(19) United States
(12) Patent Application Publication
(10) Pub. No.: US 2007/0188651 A1
(43) Pub. Date: Aug. 16, 2007

(54) Automatically capturing focused images obtained through unguided manual focus adjustment

(76) Inventor: Akihiro Machida, Sunnyvale, CA (US)

Correspondence Address: Kathy Manke;Avago Technologies Limited, 4380 Ziegler Road, Fort Collins, CO, 80525, US

(21) Appl. No.: 11/353,365

(22) Filed: Feb. 14, 2006

(51) Int. Cl. G03B 13/00; H04N 5/232

(52) U.S. Cl. 348/349

(57) ABSTRACT

In an image capture period, light from a scene is received through an optical system free of automatic focusing components. A sequence of focal values is produced from image data produced during the image capture period. One or more target focus criteria are determined from one or more of the focal values produced during a calibration portion of the image capture period. An image of the scene is automatically captured in response to a determination that one or more of the focal values produced after the calibration portion of the image capture period satisfies the target focus criteria.

### BACKGROUND

An autofocus camera includes a motor that automatically adjusts the focus of the camera optics based on signals received from a controller. In an active autofocus camera, the controller drives the motor to adjust the camera optics to an optimal focus based on a measurement of the distance to a target object. In a passive autofocus camera, the controller drives the motor to adjust the camera optics to an optimal focus based on measurements of a parameter (e.g., sharpness or contrast) of images produced by the camera optics as the focus of the camera optics is incrementally adjusted by the motor.

A manual focus camera does not include an autofocus mechanism. Instead, a manual focus camera has either fixed optics or manually adjustable optics. The focus of a manual focus camera having fixed optics is adjusted by physically moving the camera toward and away from the target object. The focus of a camera having manually adjustable optics is adjusted by manually manipulating a focus adjustment mechanism, such as a focus control knob, a lens, or a lens bezel, which controls the focus of the camera optics.

Many factors contribute to the difficulty of capturing well-focused pictures using a manual focus camera. For example, to be well-focused, a fixed optics camera must be positioned a distance from the target object that falls within a narrow range, especially when the fixed optics have a shallow depth of field. In the case of a camera with manually adjustable optics, the user must subjectively determine when the optics are focused based on a view of the target object through a viewfinder or a low resolution display that causes the sharpness of focus to be difficult to visually ascertain.

For these reasons, many approaches have been proposed for guiding users to an optimal focus during manual adjustment of a manual focus camera. Some of these approaches involve expensive active range finding mechanisms. Other approaches involve presenting a user with a visual or audible indication of a relative focus measure (e.g., sharpness or contrast) that is computed while the user manually adjusts the focus with respect to the target object. With respect to these approaches, the user can infer that the optimal focus is achieved when the visual or audible indication is maximized.

Mechanisms for guiding users to an optimal focus of a manual focus camera go a long way toward reducing the difficulty of capturing well-focused pictures using a manual focus camera. Such mechanisms, however, still require subjective determinations by the user. In addition, such mechanisms may be cumbersome to implement in some application environments, including small form factor devices and low-cost devices that may not include viewfinders or displays for viewing the target object. What are needed are systems and methods of automatically capturing focused images obtained through unguided manual focus adjustment.

### SUMMARY

In one aspect, the invention features an image capture method. In accordance with this inventive method, light from a scene is received through an optical system free of automatic focusing components in an image capture period. A sequence of focal values is produced from image data produced during the image capture period. One or more target focus criteria are determined from one or more of the focal values produced during a calibration portion of the image capture period. An image of the scene is automatically captured in response to a determination that one or more of the focal values that are produced after the calibration portion of the image capture period satisfies the target focus criteria.

The invention also features an image capture system that includes an optical system, an image sensor, and a processing system. The optical system is free of automatic focusing components and is operable to receive light from a scene. The image sensor is operable to generate image data in response to light received from the optical system. The processing system is operable to produce a sequence of focal values from the image data generated by the image sensor during an image capture period. The processing system also is operable to determine one or more target focus criteria from one or more of the focal values that are produced during a calibration portion of the image capture period. The processing system additionally is operable to cause an image of the scene to be captured in response to a determination that one or more of the focal values produced after the calibration portion of the image capture period satisfies the one or more target focus criteria.

Other features and advantages of the invention will become apparent from the following description, including the drawings and the claims.

### DESCRIPTION OF DRAWINGS

FIG. 1 is a block diagram of an embodiment of an image capture system.

FIG. 2A is a block diagram of an embodiment of an optical system in an implementation of the image capture system of FIG. 1.

FIG. 2B is a block diagram of an embodiment of an optical system in an implementation of the image capture system of FIG. 1.

FIG. 3 is a flow diagram of an embodiment of an image capture method.

FIG. 4 is a devised graph of focal values plotted as a function of time.

FIG. 5 is a block diagram of an embodiment of a telephone incorporating the image capture system of FIG. 1.

FIG. 6A is a diagrammatic top view of the telephone of FIG. 5 in an open state.

FIG. 6A is a diagrammatic top view of the telephone of FIG. 5 in a closed state.

FIG. 7 is a block diagram of an embodiment of a writing instrument incorporating the image capture system of FIG. 1.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

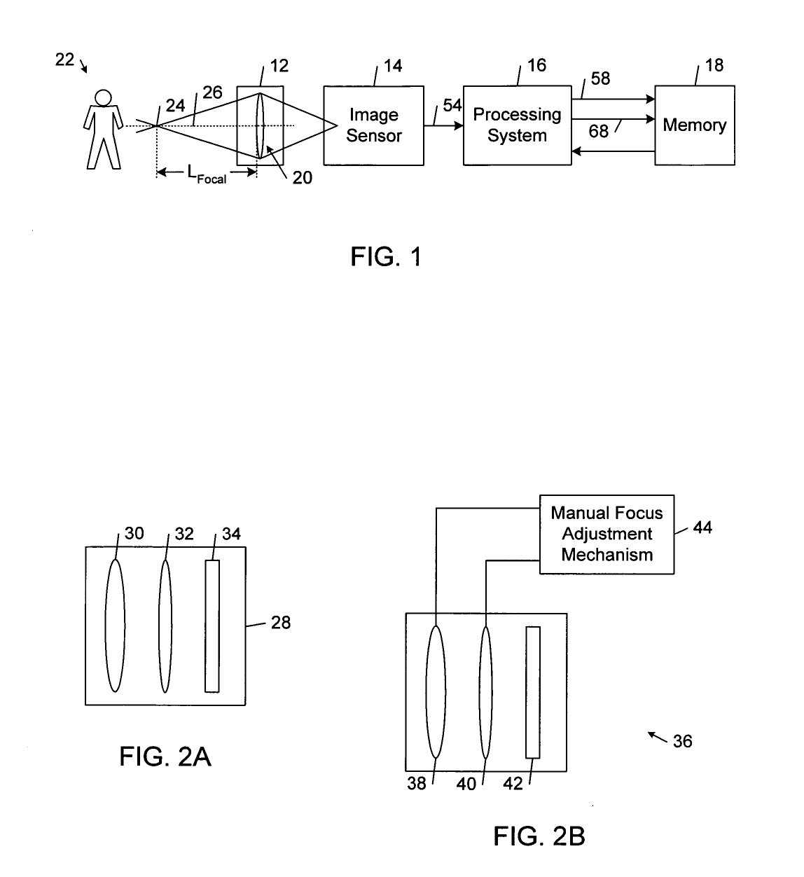

FIG. 1 shows an image capture system 10 that provides a system and implements a method of automatically capturing focused images obtained through unguided manual focus adjustment. The image capture system 10 reduces the difficulty of capturing well-focused pictures using a manual focus camera without requiring subjective determinations by the user. In addition, the image capture system 10 readily may be implemented in many different application environments, including small form factor devices and low-cost devices. For example, in some embodiments, the image capture system 10 is incorporated in a mobile device, such as a cellular telephone, a cordless telephone, a portable memory device (e.g., a smart card), a personal digital assistant (PDA), a solid state digital audio player, a CD player, an MCD player, a still image camera, a video camera, a game controller, a pager, and a laptop computer.

The image capture system 10 includes an optical system 12, an image sensor 14, a processing system 16, and a memory 18. In some embodiments, the optical system 12, the image sensor 14, and the processing system 16 are incorporated in a cameral module, which may be incorporated in a larger system or device.

The optical system 12 includes at least one lens 20 that focuses light from a scene 22 onto the active portion of the image sensor 14. The optical system 12 is characterized by a focus 24 where converging light rays emanate from a point to the optical system 12. The focal length (L_{Focal}) is the distance along the optical axis 26 of the optical system 12 from the optical system 12 to the focus 24. The optical system 12 is either a fixed-lens optical system (i.e., L_{Focal} is fixed) or a manually adjustable optical system (i.e., L_{Focal} is manually adjustable). In all implementations, however, the optical system 12 is free of any automatic focusing components, such as lens drive motors or other automatic focus adjustment mechanisms.

FIG. 2A shows a fixed-lens implementation 28 of the optical system 12 that includes a close-up lens 30, a fixed focus lens 32, and an optical filter 34. The respective positions of the close-up lens 30 and the fixed focus lenses 32 are fixed in relation to a housing in which they are contained. The combination of the close-up lens 30 and fixed-focus lens 32 gives the optical system 28 a shallow depth of field, which is the range of distances measured along the optical axis throughout which an acceptably clear and sharp image can be captured by the optical system 12. The optical filter 34 may be any type of optical filter, including an infrared optical filter and a low pass optical filter.

FIG. 2B shows a manually adjustable implementation 36 of the optical system 12 that includes a first focusing lens 38, a second focusing lens 40, and an optical filter 42. The respective positions of the first and second lenses 38, 40 are adjustable in response to user manipulation of a manual focus adjustment mechanism 44, which controls the relative positions of the first and second lenses 38, 40 and thereby controls the focus of the optical system 36. The manual focus adjustment mechanism 44 may include, for example, a focus control knob, a lens, or a lens bezel, which is coupled to a cam mechanism or the like that controls the relative positions of the lenses 38, 40.

The image sensor 14 may be any type of image sensor, including a charge coupled device (CCD) image sensor or a complementary metal-oxide-semiconductor (CMOS) image sensor.

The processing system 16 may be implemented by one or more discrete modules that are not limited to any particular hardware or software configuration and may be implemented in any computing or processing environment, including in digital electronic circuitry or in computer hardware, firmware, device driver, or software. Computer process instructions for implementing the methods performed by the processing system 16 and the data generated by the processing system 16 typically are stored in one or more machine-readable media. Storage devices suitable for tangibly embodying these instructions and data include all forms of non-volatile memory, including, for example, semiconductor memory devices, such as EPROM, EEPROM, flash memory devices, digital storage disks such as internal hard storage disks and removable storage disks.

The memory 18 may be implemented by any type of image storage technology, including a compact flash memory card and a digital video tape cassette. The image data that is stored in the memory 18 may be transferred to a storage device (e.g., a hard disk drive, a floppy disk drive, a CD-ROM drive, or a non-volatile data storage device) of an external processing system (e.g., a computer or workstation) via an external wired or wireless communications port or antenna.

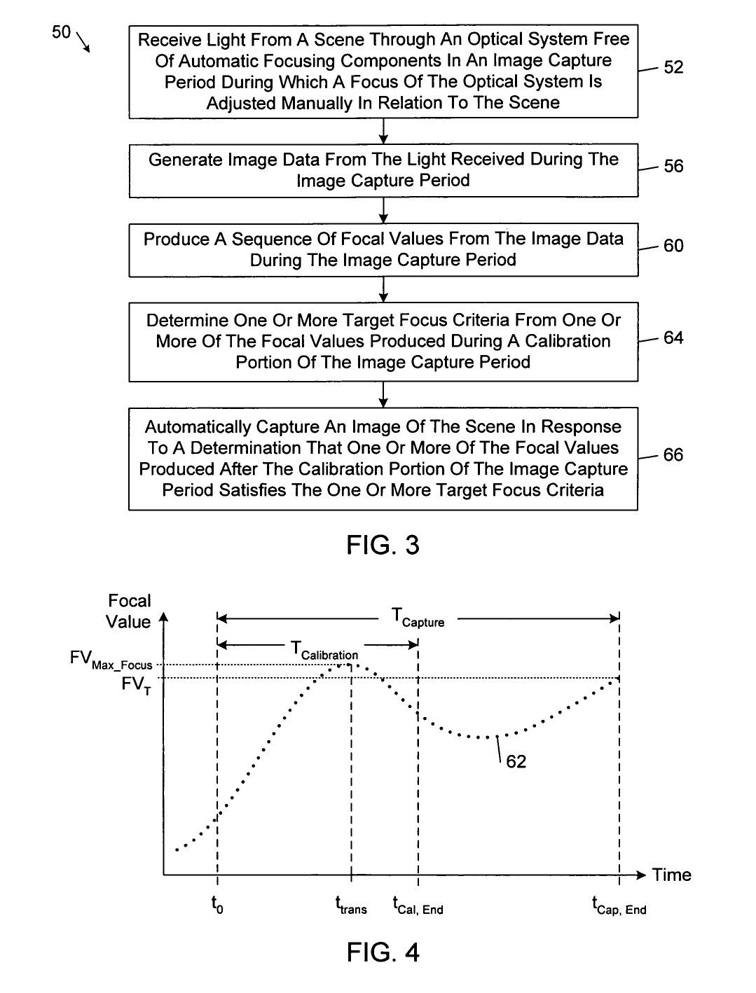

FIG. 3 shows an embodiment of an image capture method 50 that is implemented by the image capture system 10.

In accordance with the method 50, the optical system 12 receives light from the scene 22 in an image capture period during which the focus 24 of the optical system is adjusted manually in relation to the scene 22 (FIG. 3, block 52). In the case of the fixed-lens implementation 28 of the optical system 12, the focus 24 is adjusted in relation to the scene 22 by physically moving the image capture system 10 toward and away from the scene 22 during the image capture period. In the case of the manually adjustable implementation 36 of the optical system 12, the focus 24 is adjusted in relation to the scene 22 by manipulating the manual focus adjustment mechanism 44.

The image sensor 14 generates image data 54 from the light that is received by the optical system 12 and focused onto the active portion of the image sensor 14 during the image capture period (FIG. 3, block 56).

The processing system 16 produces a sequence of focal values 58 from the image data 54 during the image capture period (FIG. 3, block 60). In general, the focal values 58 correspond to any measure that correlates the focus 24 of the optical system 12 with respect to the scene 22. In some implementations, the focal values 58 are contrast focal values that measure contrast in the image data 54. The contrast focal values may be computed in any one of a wide variety of different ways. In some of these implementations, the processing system 16 computes the contrast focal values by computing energy transitions between adjacent pixels that are sampled from the image data 54, filtering out low frequency energy transitions, and combining the remaining high frequency energy transitions to produce the contrast focal values 58.

FIG. 4 shows a devised graph of a temporally ordered sequence of focal values 62 that are expected to be produced by an implementation of the processing system 16 when the image capture system 10 is used in an exemplary way to capture an image of the scene 22. In this example, the focal values 62 measure the degree of correlation between the focus 24 in relation to the scene 12. Superimposed on the graph are the boundaries of an image capture period (T_{Capture}), which extends from a beginning time (t₀) to an end time (T_{Cap., End}). In some embodiments, the user designates the beginning of the image capture period by inputting an image capture command that causes the processing system 16 to enter an image capture mode of operation. The image capture period includes an initial calibration portion (T_{Calibration}), which is used by the processing system 16 to identify a point of maximal focus between the image capture system 10 and the scene 22. The calibration period extends from an initial time (e.g., t₀ in the illustrated embodiment) and a calibration end time (t_{Cal., End}). The calibration end time may be designated by the user or may be automatically determined by the processing system 16.

In this example, the optical system 12 initially is out-of-focus with respect to the scene 22. The user then adjusts the focus 24 of the optical system 12 in relation to the scene either by moving the image capture system 10 toward or away from the scene 22 or by manually adjusting the relative positions of one or more lenses of the optical system 12. During the initial part of the calibration period (T_{Calibration}), the correlation between the focus 24 in relation to the scene 12 increases with each manual adjustment of focus from the beginning time (t₀) to a transition time (tₜᵣₐₙₛ), as indicated by the increasing focal values 62. After the transition time (tₜᵣₐₙₛ), the correlation between the focus 24 in relation to the scene 12 decreases with each manual adjustment of focus, as indicated by the decreasing focal values 62. The peak correlation between the focus 24 in relation to the scene 12 (i.e., the “maximal focus” of the optical system) occurs near the transition time (tₜᵣₐₙₛ).

In some implementations, the user designates the beginning time (t₀) of the capture period and the end point of the calibration period, and the processing system 16 identifies at least one of the largest focal values 62 produced during the calibration period. In other implementations, the user designates only the beginning time (t₀) of the capture period, and the processing system 16 automatically determines the end point of the calibration period (t_{Cal. End}) and identifies at least one of the largest focal values 62 produced during the calibration period. In these implementations, the processing system 16 determines the end point (t_{Cal., End}) of the calibration period by analyzing changes in the slope of the focal values 62 plotted over time. In some implementations, the processing system 16 identifies the transition time (tₜᵣₐₙₛ) as the time before which successive ones of the focal values predominantly vary in accordance with respective gradients of a first polarity (e.g., positive in the illustrated example) and after which successive ones of the focal values predominantly vary in accordance with respective gradients of a second polarity (e.g., negative in the illustrated example) that is opposite the first polarity. The processing system 16 identifies the end of the calibration period (t_{Cal. End}) using an empirically determined heuristic that identifies when a sufficient number of focal values have been analyzed for a change in gradient to be identified reliably.

The processing system 16 determines one or more target focus criteria from one or more of the focal values 62 that are produced during the calibration portion of the image capture period (FIG. 3, block 64). In general, the one or more target focus criteria prescribe a rule that determines the conditions under which the processing system 16 will trigger the capture of an image in the portion of the image capture period following the calibration period. In some embodiments, the processing system 16 determines a single target focus criterion that corresponds to a threshold for the focal values 62 produced after the calibration period. In other embodiments, the processing system 16 determines multiple target focus criteria that respective correspond to measurements of different imaging conditions occurring near the identified transition time (tₜᵣₐₙₛ) (e.g., focal value measurements, sharpness measurements, and brightness measurements).

In some implementations, the processing system 16 determines the focal value 58 (FV_{MAX}_{_{—}}_{FOCUS}) that corresponds to the highest correlation between the focus 24 of the optical system 12 with respect to the scene 22. For example, with respect to the example shown in FIG. 4, the processing system 16 identifies the highest focal value measure that is produced during the calibration portion of the image capture period. In some of these implementations, the processing system 16 determines a target focus criterion that corresponds to a threshold focal value (e.g., FV_{T}) that is equals to an empirically determined fraction of the identified focal value (FV_{MAX}_{_{—}}_{FOCUS}). That is,
FV_{T}=α·FV_{MAX}_{_{—}}_{FOCUS} (1)
where 0<α≦1.

After the one or more target focus criteria have been determined, the processing system 16 causes the image capture system 10 to automatically capture an image of the scene 22 in response to a determination that one or more of the focal values produced after the calibration portion (T_{Calibration}) of the image capture period (T_{Capture}) satisfies the one or more target focus criteria (FIG. 3, block 66). In this process, the processing system 16 compares the focal values produced after the calibration portion of the image capture period with the one or more target focus criteria. The processing system 16 causes the image of the scene 22 to be automatically captured independently of any user input command. In some embodiments, the processing system 16 generates a shutter control signal that causes the image to be captured. In other embodiments, the processing system 16 processes the image data 54 into a discrete image file 68 that is stored in the memory 18. In this regard, the processing system 16 may process the image data 54 in any one of a wide variety of different ways. For example, the processing system 16 may demosaic and color-correct the image data 54. The processing system 16 may generate compressed image files 68 from the demosaiced and color-corrected image data 54 in accordance with an image compression process (e.g., JPEG). After the image has been captured, the processing system may generate a signal that triggers and audible or visual notification that indicates to the user that an image has been captured.

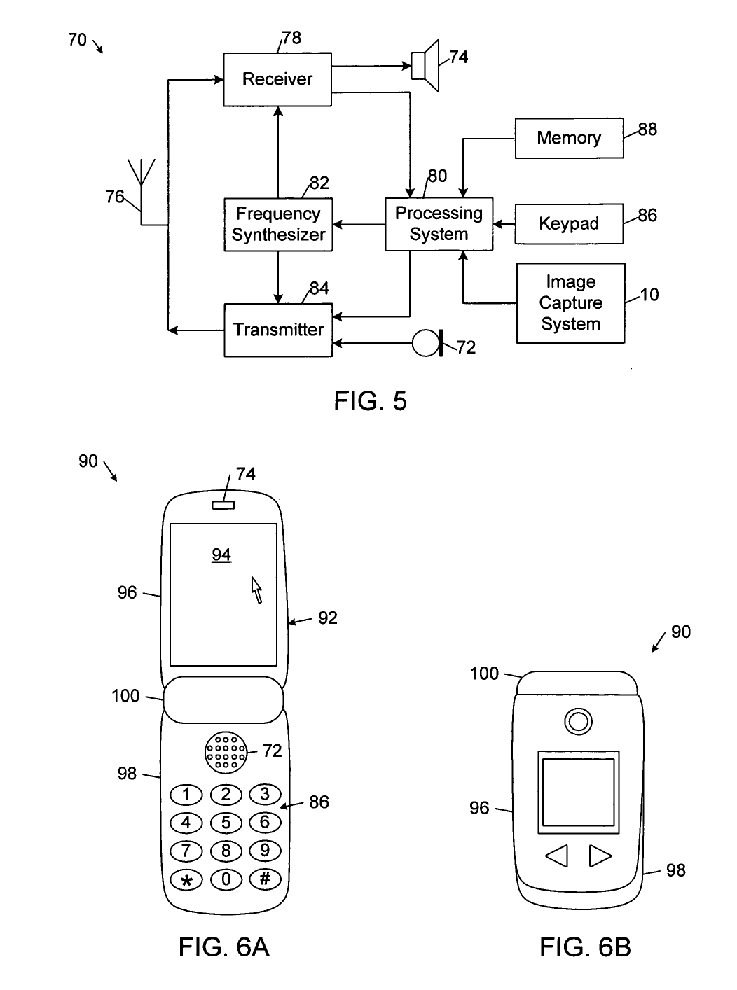

FIG. 5 shows an embodiment of a telephone 70 that incorporates the image capture system 10. The telephone 70 may correspond to any of a variety of different types of telephones, including a wired telephone and a wireless telephone (e.g., a cellular telephone and a cordless telephone). The telephone 70 transduces between audio signals and telephony signals. In this regard, the telephone 70 includes a microphone 72 for converting received audio signals into electrical signals and a speaker 74 for converting received electrical signals into audio signals. The telephone 70 communicates the telephony signals over a telephony communications channel, which couples the telephone 70 to a telephone system, which may include one or more of a wireless telephone network, a wired telephone network (e.g., a PSTN), and a cordless telephone base station. The telephony signals may formatted in accordance with any of a variety of different telephone protocols, including public switched telephone network protocols (e.g., Signaling System 7 and Intelligent Network), analog cellular telephone protocols (e.g., Advanced Mobile Phone Service), digital cellular telephone protocols (e.g., TDMA, CDMA, GSM, and WAP), and cordless telephone protocols (e.g., Digital Enhanced Cordless Telecommunications).

The telephone 70 additionally includes an antenna 76, a receiver 78, the speaker 74, a processing system 80, a frequency synthesizer 82, a transmitter 84, the microphone 72, a keypad 86, and a memory 88. The processing system 80 choreographs the operation of the receiver 78, the transmitter 84, and the frequency synthesizer 82. The frequency synthesizer 82 sets the operating frequencies of the receiver 78 and the transmitter 84 in response to control signals received from the processing system 80.

FIG. 6A shows an embodiment 90 of the telephone 70 that includes a housing 92, a display screen 94, the keypad 86, the microphone 72, and the speaker 74. The display screen 94 and the speaker 74 are exposed through an inner face of a top part 96 of the housing 92. The keypad 86 and the microphone 72 are exposed through an inner face of a bottom part 98 of the housing 92. The top and bottom parts 96, 98 of the housing 92 are connected together by a hinged portion 100, which allows the top and bottom parts 96, 98 to pivot between an open state and a closed state. In the open state shown in FIG. 6A, a user has access to the displays screen 94, the keypad 866, the microphone 72, and the speaker 74.

FIG. 6B shows a top view of the handheld device 90 in the closed state. As shown in this view, the top part 96 of the housing 92 includes right and left input buttons 102, 104, a display 106, and an optical port 108 through which light is received by the image capture system 10. One or both of the input buttons 102, 104 may be configured to communicate user commands to the image capture system 10. In some embodiments, user commands may be communicated to the image capture system 10 via the keypad 86.

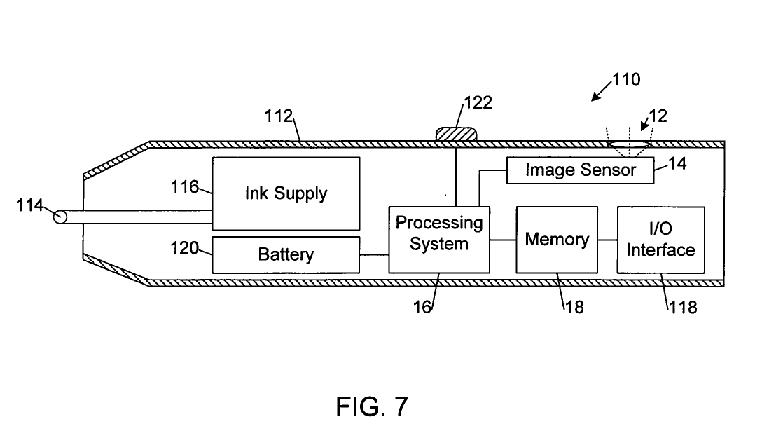

FIG. 7 shows an embodiment of an electronic writing device 110 that includes an elongated housing 112 that is sized and shaped in the form of a writing instrument (e.g., a pen, pencil, or stylus). In this embodiment, the electronic writing device 110 includes a writing tip 114 that is connected to an ink supply 116. The writing tip 114 is configured to deposit ink from the ink supply 116 onto a writing medium as the writing tip is pressed against and moved across the surface of the writing medium. In other embodiments, the writing tip 114 and the ink supply 116 may be replaced by a different dispensing mechanism and a different corresponding marking agent (e.g., graphite), respectively.

The image capture system 10 is incorporated in the housing 112. In particular, the optical system 12 receives light through an optical port that is formed through a wall of the housing 112. The image sensor 14 is adjacent the optical system 12. The processing system 14 is electrically coupled to the image sensor 14 and the memory 18. The memory 18 stores data generated by the processing system 16, including temporary data, intermediate data, data sampled from the image sensor 14. In some implementations, memory 18 is an erasable, rewritable memory chip that holds its content without power, such as a flash RAM or a flash ROM memory chip. Other implementations may use a different type of memory.

The electronic writing device 110 additionally includes an input/output (I/O) interface 118, a battery 120, and a power button 122.

The I/O interface 118 provides a hardware interface for communications between the electronic writing device 110 and a remote system. The I/O interface 118 may be configured for wired or wireless communication with the remote system. In some implementations, the I/O interface 118 provides a bi-directional serial communication interface. The remote system may be any type of electronic device or system, including a workstation, a desktop computer, a portable computing device (e.g., a notebook computer, a laptop computer, a tablet computer, and a handheld computer), a cash register or point-of-sale terminal. A docking station may be used to connect the I/O interface 118 to the remote system. In some implementations, the remote system may be located at a location remote from the user. For example, the remote system may be a central server computer located at a remote node of a computer network and data from the electronic writing device 110 may be uploaded to the central server computer from any network node connected to the central server computer.

The battery 120 may be any type of battery that provides a source of direct current (DC), including a rechargeable type of battery (e.g., a nickel metal hydride rechargeable battery of a lithium polymer rechargeable battery) and a non-rechargeable type of battery. The battery 120 supplies DC power to the electrical components of the electronic writing device 110.

The power button 122 may be depressed by a user to activate and deactivate the image capture device 10.

Other embodiments are within the scope of the claims.

What is claimed is:

1. An image capture method, comprising:
receiving light from a scene through an optical system free of automatic focusing components in an image capture period during which a focus of the optical system is adjusted manually in relation to the scene;
generating image data from the light received during the image capture period;
producing a sequence of focal values from the image data during the image capture period;
determining one or more target focus criteria from one or more of the focal values produced during a calibration portion of the image capture period; and
automatically capturing an image of the scene in response to a determination that one or more of the focal values produced after the calibration portion of the image capture period satisfies the one or more target focus criteria.

2. The method of claim 1, wherein the optical system has a fixed focal length, and further comprising manually adjusting the focus of the optical system by physically moving the optical system toward and away from the scene during the image capture period.

3. The method of claim 1, wherein the producing comprises generating contrast focal values measuring contrast in the image data.

4. The method of claim 3, wherein the determining comprises identifying a target one of the contrast focal values generated during the calibration portion of the image capture period.

5. The method of claim 4, wherein the capturing comprises automatically capturing the image of the scene in response to a determination that one of the contrast focal values generated after the calibration portion of the image capture period is at least as high as the identified target focal value.

6. The method of claim 4, wherein the identified target contrast focal value corresponds to a maximal one of the focal contrast values generated during the calibration portion of the image capture period.

7. The method of claim 1, wherein the determining comprises identifying the calibration portion of the image capture period based on user input defining the boundaries of the calibration portion.

8. The method of claim 1, wherein the determining comprises identifying the calibration portion of the image capture period by identifying when successive ones of the focal values produced before a transition time predominantly vary in accordance with respective gradients of a first polarity and successive ones of the focal values produced after the transition time predominantly vary in accordance with respective gradients of a second polarity opposite the first polarity.

9. The method of claim 1, wherein the capturing comprises comparing the focal values produced after the calibration portion of the image capture period with the one or more target focus criteria.

10. The method of claim 1, wherein the capturing comprises automatically capturing the image of the scene independently of any user input command.

11. An image capture system, comprising:
an optical system free of automatic focusing components and operable to receive light from a scene;
an image sensor operable to generate image data in response to light received from the optical system; and
a processing system operable to
produce a sequence of focal values from the image data generated by the image sensor during an image capture period,
determine one or more target focus criteria from one or more of the focal values produced during a calibration portion of the image capture period, and
cause an image of the scene to be captured in response to a determination that one or more of the focal values produced after the calibration portion of the image capture period satisfies the one or more target focus criteria.

12. The system of claim 11, wherein the optical system has a fixed focal length.

13. The system of claim 11, wherein the processing system is operable to generate contrast focal values measuring contrast in the image data.

14. The system of claim 13, wherein the processing system is operable to identify a target one of the contrast focal values generated during the calibration portion of the image capture period.

15. The system of claim 14, wherein the processing system is operable to cause the image of the scene to be captured in response to a determination that one of the contrast focal values generated after the calibration portion of the image capture period is at least as high as the identified target focal value.

16. The system of claim 14, wherein the identified target contrast focal value corresponds to a maximal one of the focal contrast values generated during the calibration portion of the image capture period.

17. The system of claim 11, wherein the processing system is operable to identify the calibration portion of the image capture period based on user input defining the boundaries of the calibration portion.

18. The system of claim 11, wherein the processing system is operable to identify the calibration portion of the image capture period by identifying when successive ones of the focal values produced before a transition time predominantly vary in accordance with respective gradients of a first polarity and successive ones of the focal values produced after the transition time predominantly vary in accordance with respective gradients of a second polarity opposite the first polarity.

19. The system of claim 11, wherein the processing system is operable to compare the focal values produced after the calibration portion of the image capture period with the one or more target focus criteria.

20. The system of claim 11, wherein the processing system is operable to cause the image of the scene to be automatically captured independently of any user input command.
